(19) United States
(12) Patent Application Publication
(10) Pub. No.: US 2024/0330686 A1
(43) Pub. Date: Oct. 3, 2024

(54) ACCELERATING PRIVACY-PRESERVING NEURAL NETWORKS AND AN EFFICIENT SKIP-CONNECTION REALIZATION THEREOF

(71) Applicant: International Business Machines Corporation, Armonk, NY (US)

(72) Inventors: Itamar Zimerman, Tel-Aviv (IL); Nir Drucker, Zichron Yaakov (IL); Moran Baruch, Petah Tikva (IL); Omri Soceanu, HAIFA (IL)

(21) Appl. No.: 18/127,700

(22) Filed: Mar. 29, 2023

(51) Int. Cl. G06N 3/082; G06N 3/0464

(52) U.S. Cl. CPC G06N 3/082; G06N 3/0464

(57) ABSTRACT

A skip-connections analysis method, system, and computer program product for accelerating neural networks by removing skip-connections and efficient skip-connection realization.

### BACKGROUND

The present invention relates generally to a skip-connections analysis method, and more particularly, but not by way of limitation, to a system, method, and computer program product for removing skip-connections from a network without (or minimal) performance degradation and proposing efficient alternatives to skip-connections.

Homomorphic Encryption (HE) is a cryptographic tool that allows performing computation under encryption, which is used by many privacy-preserving machine learning solutions, for example, to perform secure classification.

Modern deep learning applications yield good performance in image processing tasks benchmarks by including many skip-connections (i.e., residual connections). However, these techniques have a technical problem in that the modern deep learning applications are very costly when attempting to execute model inference under HE.

Also, protecting sensitive data is crucial when using, as one example, third-party cloud environments, particularly for complying with regulations. As a result, many industries seek solutions that provide data privacy and confidentiality.

Some solutions have either removed skip connections all together or just accepted skip connection placement as a given and automatically bootstrapped whenever chain indices didn't align.

Conventionally, one potential solution is using the HE, which enables computation on encrypted data. HE has been identified as a technology with significant potential in the Privacy-Preserving Machine Learning (PPML) market. Despite the potential, there are obstacles to the widespread adoption of HE solutions, including lack of standardization, limitations on the types of computation that can be performed with practical latency and accuracy, etc.

That is, there is a technical problem in the art of training HE-friendly, encrypted or unencrypted, deep convolutional neural networks (CNNs) with decent accuracy.

### SUMMARY

In view of the above-mentioned problems in the art, the inventors have considered a technical solution that includes improving the performance of HE-friendly CNNs and reducing the latency of encrypted inference operations. This technical solution can also improve encrypted training operations because a model without skip-connections is simpler to train under HE.

Thereby, the invention provides a technical solution that trains HE-friendly (polynomial) deep CNNs at an accuracy that is similar to the original non-HE-friendly networks over large-scale datasets.

Also, the invention provides another technical solution to the technical problem in the art by providing HE-aligned skip-connection, replacing (mid-term) skip-connections with (short-term) Dirac parameterization, and (long-term) shared-source skip-connection to reduce the skip-connections burden for HE-based solutions, thereby achieving increased computing power improvement for the same accuracy.

In an exemplary embodiment, the present invention can provide a computer-implemented skip-connections analysis method for accelerating neural networks by removing skip-connections, the method including training a network with skip-connections, and breaking a dependency within the network on the skip-connections. Therefore, the present invention can provide an advantage of dramatically reducing latency for neural networks with skip-connections.

In another exemplary embodiment, the present invention can provide a skip-connections analysis computer program product for accelerating neural networks by removing skip-connections, the skip-connections analysis computer program product including a computer-readable storage medium having program instructions embodied therewith, the program instructions executable by a computer to cause the computer to perform: training a network with skip-connections, and breaking a dependency within the network on the skip-connections. Therefore, the present invention can provide an advantage of dramatically reducing latency for neural networks with skip-connections.

In another exemplary embodiment, the present invention can provide a skip-connections analysis system for accelerating neural networks by removing skip-connections, the skip-connections analysis system including a processor, and a memory, the memory storing instructions to cause the processor to perform: training a network with skip-connections, and breaking a dependency within the network on the skip-connections. Therefore, the present invention can provide an advantage of dramatically reducing latency for neural networks with skip-connections.

In another exemplary embodiment, the present invention can provide a computer-implemented skip-connections analysis method for an efficient skip-connection realization, the method including optimizing a network by identifying skip-connections to maintain while reducing latency. Therefore, the present invention can provide an advantage of identifying skip-connections that do not require extra work to complete to maximize latency efficiency of the network.

In another exemplary embodiment, the present invention can provide a skip-connections analysis system for an efficient skip-connection realization, the system including a processor, and a memory, the memory storing instructions to cause the processor to perform: training the network with the skip-connections, running an analyzer to compute a cost of having the skip-connections between layers of the network, adding and/or removing the skip-connections from the network based on a result of the analyzer, and returning the modified network based on a result of the adding and/or removing. Therefore, the present invention can provide an advantage of modifying the placement of the skip-connections to have the same network but the network be more efficient.

In another exemplary embodiment, the present invention can provide a computer-implemented skip-connections analysis method where the breaking the dependency within the network includes: replacing skip-connections with ST-SC layers, training the network for N epochs where e is an epoch index such that a=(1−e/N), and returning the network without the skip-connections. Therefore, the present invention has an advantage that can result in the same accuracy, but with 25% of the bootstraps, and 40% of the latency.

In another exemplary embodiment, the present invention can provide a computer-implemented skip-connections analysis method where, starting from a pre-trained model, the optimizing includes: training the network with the skip-connections, running an analyzer to compute a cost of having the skip-connections between layers of the network, adding and/or removing the skip-connections from the network based on a result of the analyzer, and returning the modified network based on a result of the adding and/or removing. Therefore, the present invention has an advantage of changing a placement of skip-connections for a more FHE-Friendly-neural-network.

In another exemplary embodiment, the present invention can provide a computer-implemented skip-connections analysis where, starting without a pre-trained model, the optimizing includes: running an analyzer to compute a cost of having the skip-connections between layers of the network, starting from an initial layer of the network, finding a first layer with a minimal cost to add a skip-connection to the first layer, training the modified network, and returning the modified network. Therefore, the present invention has an advantage of changing a placement of skip-connections for a more FHE-Friendly-neural-network.

Other details and embodiments of the invention will be described below, so that the present contribution to the art can be better appreciated. Nonetheless, the invention is not limited in its application to such details, phraseology, terminology, illustrations and/or arrangements set forth in the description or shown in the drawings.

Rather, the invention is capable of embodiments in addition to those described and of being practiced and carried out in various ways and should not be regarded as limiting.

As such, those skilled in the art will appreciate that the conception upon which this disclosure is based may readily be utilized as a basis for the designing of other structures, methods and systems for carrying out the several purposes (and others) of the present invention. It is important, therefore, that the claims be regarded as including such equivalent constructions insofar as they do not depart from the spirit and scope of the present invention.

### BRIEF DESCRIPTION OF THE DRAWINGS

Aspects of the invention will be better understood from the following detailed description of the exemplary embodiments of the invention with reference to the drawings, in which:

FIG. 1 exemplarily shows a high-level flow chart for a skip-connections analysis method 100 for accelerating privacy-preserving neural networks by removing skip-connections according to an embodiment of the present invention;

FIG. 2 exemplarily shows a high-level flow chart for a skip-connections analysis method 200 for an efficient skip-connection realization technique for privacy-preserving neural networks according to a second embodiment of the present invention;

FIG. 3 exemplarily shows a high-level flow chart for a skip-connections analysis method 300 according to a third embodiment of the present invention;

FIG. 4 exemplarily depicts an end-to-end PPML solution for running CNNs over HE;

FIG. 5-9 exemplarily depict conventional technical problems in the art;

FIG. 10 exemplarily depicts a removal technique for skip-connections according to an embodiment of the present invention;

FIG. 11 exemplarily depicts a result of eliminating skip-connections on latency and the number of bootstraps for HE-friendly ResNet-50 with polynomial activations of fixed degrees according to an embodiment of the present invention;

FIG. 12 is an exemplary algorithm for designing efficient HE-friendly CNNs according to an embodiment of the present invention;

FIG. 13 exemplarily depicts a conventional technical problem in the art;

FIG. 14 exemplarily depicts a standard ResNet network with skip-connections;

FIG. 15 exemplarily depicts a modification of FIG. 14 according to an embodiment of the present invention;

FIG. 16 depicts a computing environment 100 according to an embodiment of the present invention.

### DETAILED DESCRIPTION

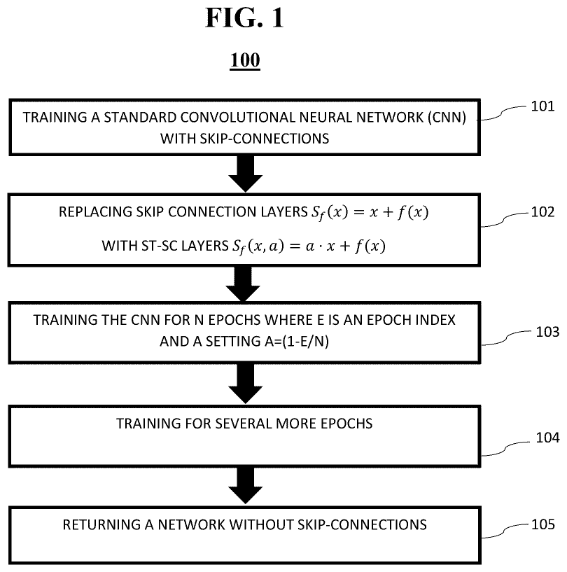

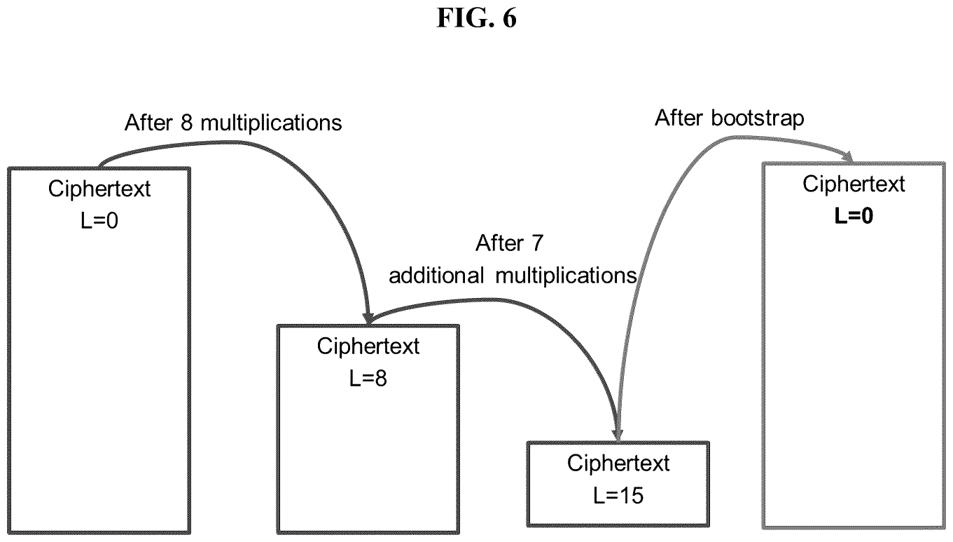

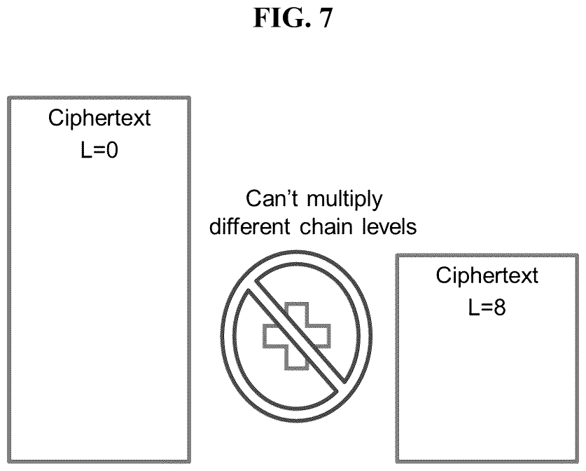

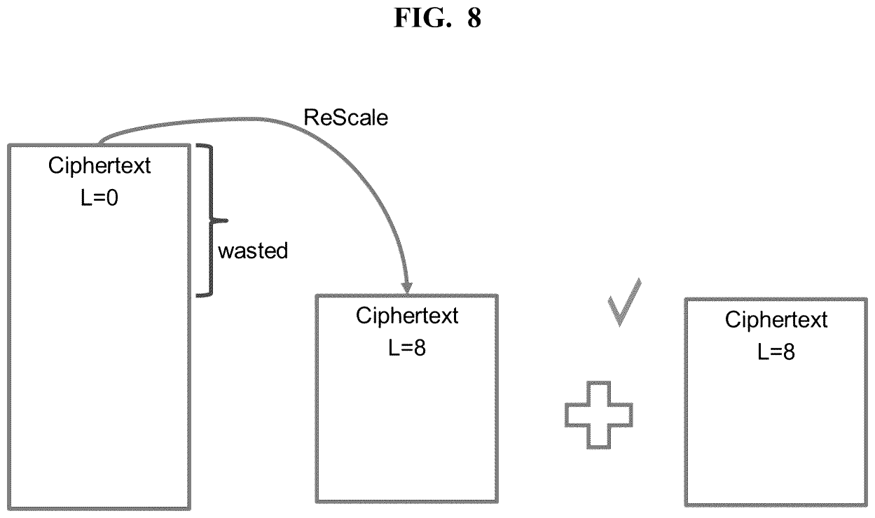

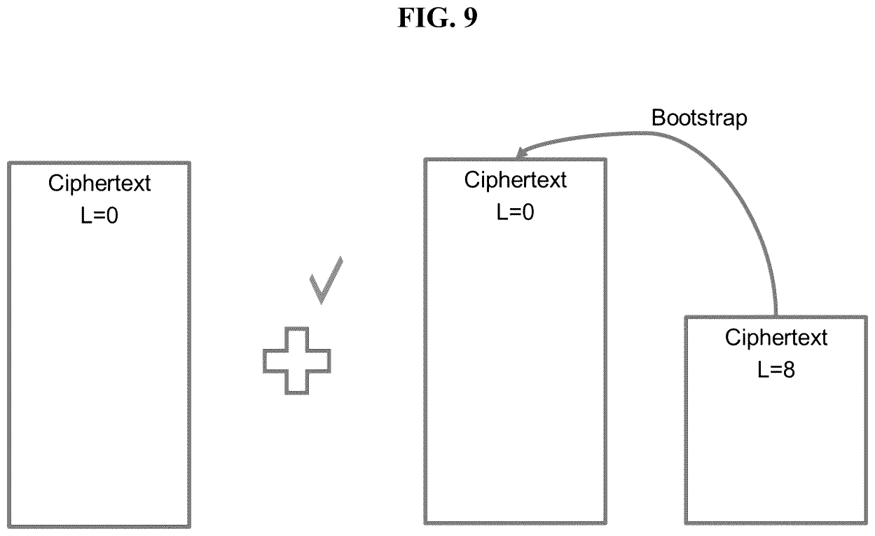

The invention will now be described with reference to FIGS. 1-16, in which like reference numerals refer to like parts throughout. It is emphasized that, according to common practice, the various features of the drawing are not necessarily to scale. On the contrary, the dimensions of the various features can be arbitrarily expanded or reduced for clarity.

With reference now to the exemplary method 100 depicted in FIG. 1, the invention includes various steps for a technique to remove skip-connections from a network with minimal performance degradation by training the network with skip-connections and using a smooth transition technique, thereby to break the dependency on the skip-connection layers.

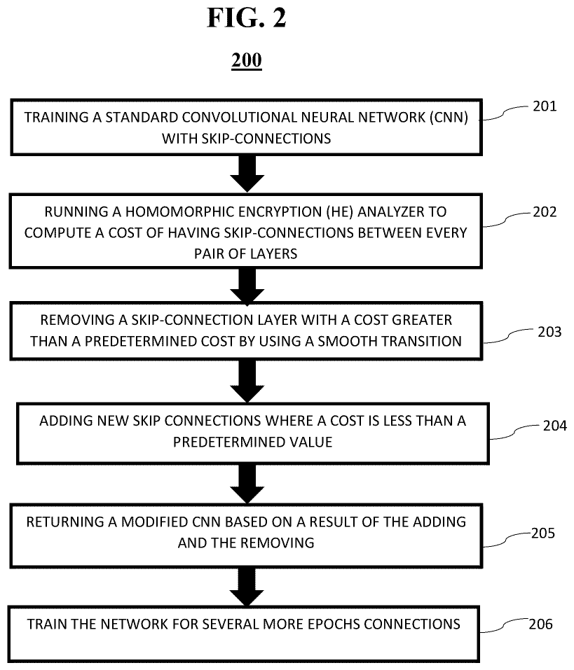

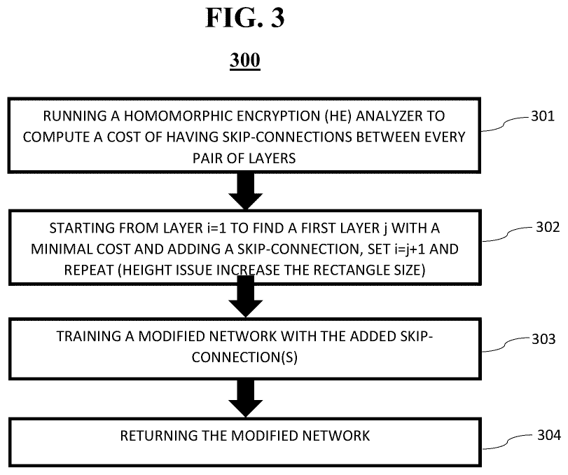

With reference now to the exemplary methods 200 and 300 depicted in FIGS. 2-3, the invention includes various steps for a technique to optimize a network by identifying how to maintain skip-connections while reducing latency.

The skip-connections analysis method 100 according to an embodiment of the present invention may act in a more sophisticated, useful and cognitive manner, giving the impression of cognitive mental abilities and processes related to knowledge, attention, memory, judgment and evaluation, reasoning, and advanced computation. A system can be said to be “cognitive” if it possesses macro-scale properties-perception, goal-oriented behavior, learning/memory and action—that characterize systems (i.e., humans) generally recognized as cognitive.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It is noted that an “HE-friendly CNN” means one that contains only polynomial components.

Further, it is noted that “skip-connections” means a way to connect two or more layer-outputs using, for example, addition. It is called skip connections because the output data from of ‘past’ layers can ‘skip’ some layers in the network and affect layers further up the network.

And, it is noted that “skip-connections” and “skip-connection layers” are used interchangeably.

For example, with each layer of a neural network, skip-connections are operations between a layer and a layer down the line. Typically, when running encrypted inference operation over an existing neural network, there is some time (i.e., a latency as a cost) that needs to be spent to move and/or handle the layer data under encryption so that the operations can occur between the layers). However, there can be identified certain layers where there is a reduced need for sorting or reorganizing such that there is a reduced latency. The invention includes identifying these skip-connections (i.e., where a skip-connection can be placed between layers to incur reduced cost), and either add skip-connections to these spots, remove other skip-connections that require reorganization so that the invention maximizes the cost (e.g., minimal latency).

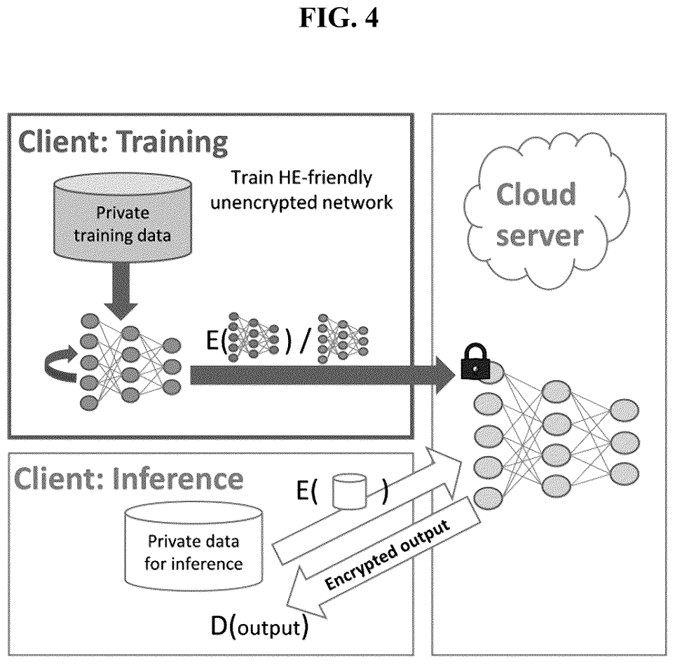

FIG. 4 exemplarily depicts an end-to-end PPML solution for running CNNs over HE of which the invention can operate thereon. The flow involves a client and a cloud server. First, the client trains an unencrypted HE-friendly CNN model, chooses whether to encrypt it or not, and uploads the model to the cloud. The client can then request from the cloud to run this model on their behalf. For this purpose, the client encrypts several private samples and uploads them to the cloud, which processes the encrypted data using the (possibly encrypted) model and returns the results to the client for decryption.

That is, at a high-level, HE schemes allow one to perform operations on encrypted data. HE instantiations typically rely on the complexity of the Ring-Learning With Errors (LWE) problem for security and support Single Instruction Multiple Data (SIMD) operations. The HE system has an encryption operation Enc: R1→R2 that encrypts input plaintext from the ring R1(+,*) into ciphertexts in the ring R2(⊕,⊙) and an associated decryption operation Dec: R2→R1. An HE scheme is correct if for every valid input x, y∈R1 for equations (1)-(3) and is approximately correct if for some small ∈>0 that is determined by the key, it follows that |x−Dec(Enc(x)|≤ε. Equations 2, and 3 are modified in the same way.

$$Dec ( Enc ( x ) ) = x \qquad ( 1 )$$

$$Dec ( Enc ( x ) ⊕ Enc ( y ) ) = x + y \qquad ( 2 )$$

$$Dec ( Enc ( x ) ▯ Enc ( y ) ) = x * y \qquad ( 3 )$$

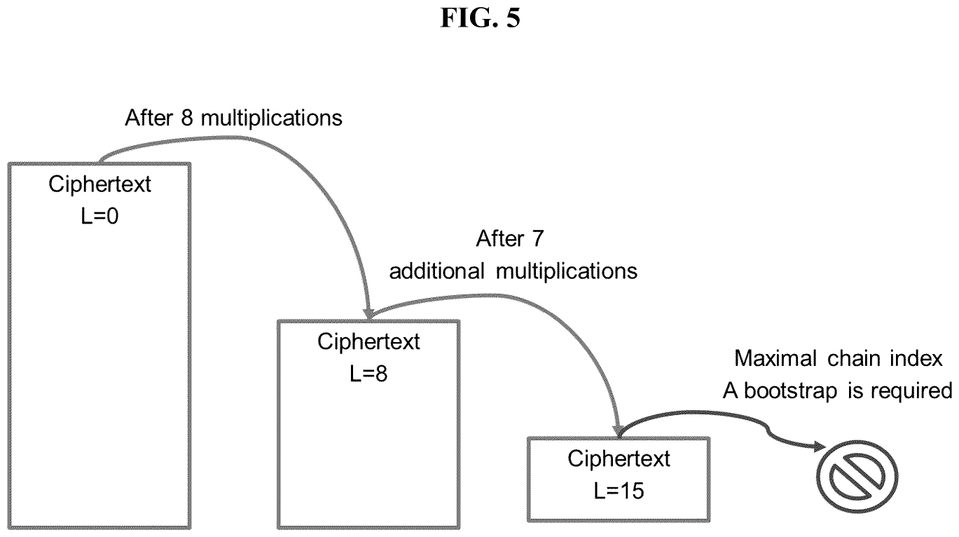

Further, as depicted in FIGS. 5-9, schemes have a limit on the number of multiplications that can be performed on a ciphertext, known as the “multiplication chain index” (a.k.a. “modulus chain index”) or CIdx. This limit is set by the client to achieve the desired level of security and performance. Every ciphertext starts with a CIdx of 0. After each multiplication of two ciphertexts with CIdx of x and y, the result has a CIdx of max(x, y)+1. Once a ciphertext's CIdx reaches the limit, it can no longer be multiplied, unless a costly Bootstrap operation is performed to reduce its CIdx, or even reset it back to 0.

Hereafter, the term “multiplication depth” is defined to be the longest chain of sequential multiplication operations in an HE evaluated function. As noted above, longer chains (i.e., higher multiplication depths) result in more bootstrapping operations.

With reference generally to FIG. 1, the invention gradually (i.e., one after the next) removes skip-connections from trained models by using a smooth transition (i.e., replacing the skip-connection layer S_f(x)=x+f(x) with S_f(x, a)=a*x+f(x), where it is trained for n more epochs and set a=(1−e/n) to eliminate the contribution of x). It is noted that “a” is the “smooth transition” parameter to change the skip-connections. And, “a” is the coefficient of the skip connection that vanishes when e=N.

That is, the invention is based on the observation that, given a skip-connection layer S_{f}(x)=x+f(x), where f is a combination of some layers. When running under HE:
1. CIdx(S_{f}(x))∈{CIdx(x), CIdx(f(x))}
2. When CIdx(x)≠CIdx(f(x)) the skip-connections implantation invokes either a ReScale or a Bootstrap operation and may increase the overall multiplication depth of the network by CIdx(x)−CIdx(f(x))|.

However, in practice, the cost of S_{f}(x) can be even higher because the input x or f(x) may need to go through some transformation before adding it to f(x).

Therefore, given the latency costs associated with implementing skip-connections under HE, the invention includes an approach that brings knowledge from the artificial intelligence (AI) domain into the HE domain. Particularly, in on exemplary embodiment, the invention replaces DNNs skip-connections with Dirac parameterization and shared-source skip-connection. Indeed, shared-source skip-connections connect the output of the initial layer or input with the output of different locations in the network. The reason this reduces the number of bootstraps is that after the initial layer, the chain index is very low. In addition, these connections can be added only to layer outputs that share the same tile tensor shape and thus save reshape operations.

Dirac parameterization is explained as follows: let σ(x) be a function that combines non-linearity and batch normalization, then a standard convolutional layer in ResNet is of an explicit form y=x+σ(W⊏x), where a Dirac parameterization is of the form y=σ(diag(a)|+W)□x=σ(diag(a)x+W□x). This addition helps training and does not affect the latency of the secure inference.

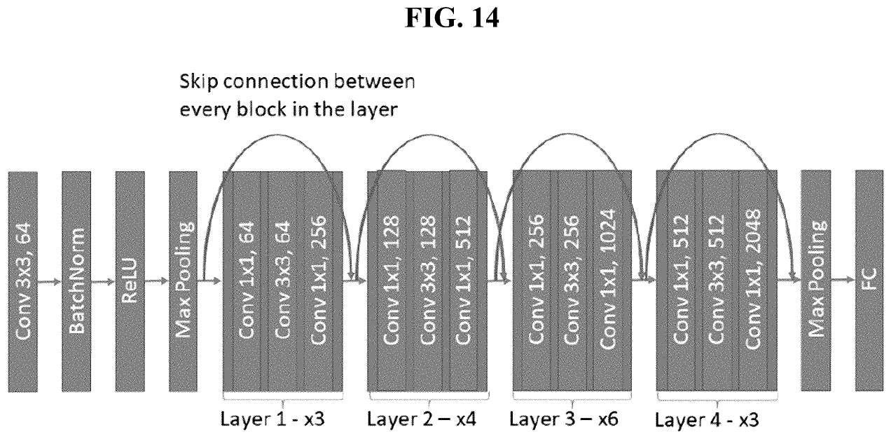

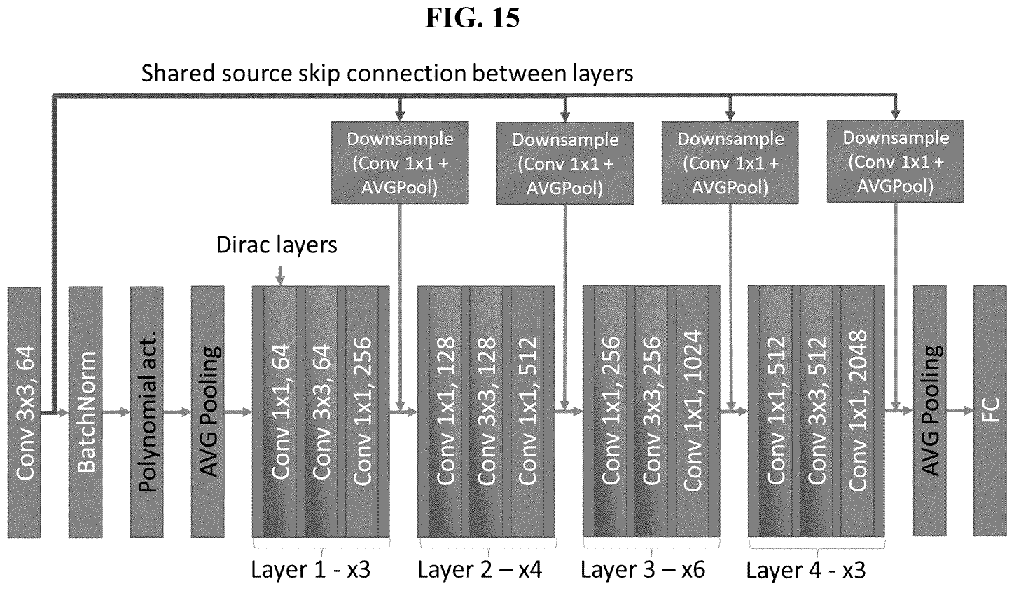

FIG. 14 shows a standard ResNet network with skip-connection in their original places. In contrast, FIG. 15 shows a modification according to the method 100. Because HE only supports polynomial operations, the non-polynomial layers are replaced with polynomial layers to achieve a HE-friendly network. Specifically, MaxPool is replaced with AVGPooling and ReLU activations with polynomial activations.

Subsequently, all mid-term skip-connections are removed and long-term shared-source connections are added from the output of the first convolution layer to every one of the four layers' outputs. To ensure that the dimensions match, 1×1 convolutional is added and average pooling layers to these connections. Note that these layers can be performed on the server side but also by the client if a split network is considered, where the first layer is performed on the client side. This offers a tradeoff between latency and bandwidth. Finally, low-term Dirac parameterization is added to the first two convolution layers of every block, where the stride is 1.

Given the latency costs associated with implementing skip-connections under HE, the invention includes methods 100, 200, and 300 for placement and removal of skip-connections, where the goal is to maintain accuracy while improving latency.

More specifically, in step 101, a standard convolutional neural network (CNN) is trained with skip-connections.

In step 102, skip-connection layers S_{f}(x)=x+f(x) are replaced with the smooth transition skip-connection (ST-SC) layers S_{f}(x,α)=α·x+f(x), and, in step 103, the CNN for N epochs where e is an epoch index and a setting a=(1−e/N) is trained. It is noted that this is one (uniform) embodiment but other embodiments can be used.

For example, in another embodiment of step 102, step 102 can be generalized to any type of connection between different layers, not just the standard skip-connections. For example, the U-NET backbone (developed before skip-connections) contains connections between different layers to handle multi-scale dependencies for computer vision/image processing. In this scenario, using naïve implementation of U-NET in HE can be ineffective, and by modifying the connections corresponding to the HE optimizer (or analyzer) one can obtain a much more HE-effective UNET variant.

In step 104, the training occurs for several more epochs (i.e., repeats until a budget is exhausted). And, in step 105, the network is returned without skip-connections.

It is noted that, in an alternate embodiment, the invention can remove the skip-connections one-by-one based on different policies (e.g., starting from the skip-connection that connects the lower layers first).

Or, when there is more than a single skip-connection, method 100 can remove them all at once.

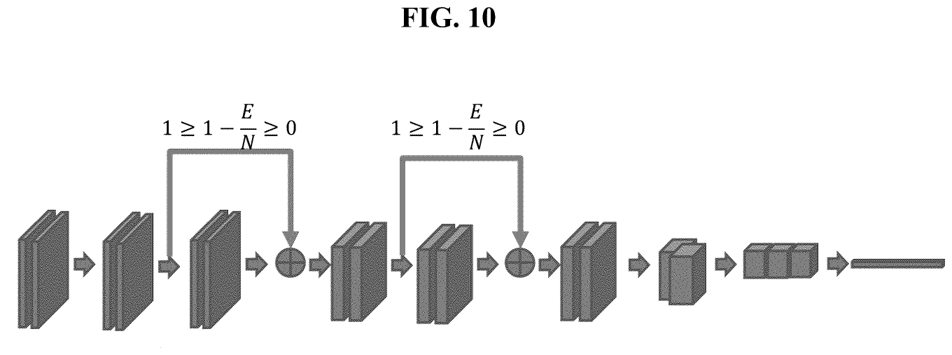

Indeed, based on the method 100 disclosed in FIG. 1, at a high-level, the invention trains the network with skip-connections and breaks the dependency on the skip-connection layers using a smooth transition technique (e.g., such as shown in FIG. 10). Thus, skip-connections are removed via method 100 with minimal performance degradation.

That is, method 100 can generate a CNN without skip-connections while maintaining near-standard performance. Removing skip-connections directly will result in bad performance due to the gradient flow across layers. Therefore, in the method 100, it is started by training a CNN to achieve standard performance while using skip-connections. The method 100 gradually eliminates them by replacing S_{f}(x) with a new layer S_{f,α}′(x)=α· g(x)+h(f(x)). This is continued and trained for N more epochs. After N epochs, a=0 and the skip-connections are removed.

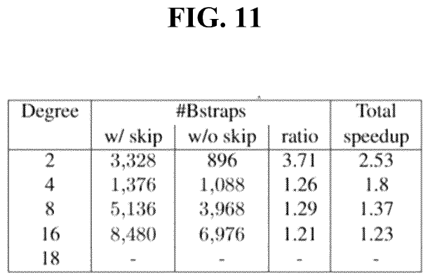

For example, FIG. 11 demonstrates the effect of using the method 100 of carefully removing skip-connections on secure classification latency. For that, ResNet-50 is used and set the polynomial activations degree of the entire network to be in the range 2 and 16. FIG. 11 shows that using HE-friendly skip-less models can save up to 75% of the bootstrapping as well as provide significant speedup.

With reference now to FIGS. 2-3, the invention involves using an HE analyzer (e.g., the HELayers optimizer) that receives the original architecture without skip-connection as input and evaluates the cost of adding skip-connections between layers 0<i<j<L, where Lis the number of layers. Based on this analysis, the invention can remove and/or add skip-connections and retrain the network.

As shown in FIG. 2 and starting from a pre-trained model, in step 201, a standard convolutional neural network (CNN) is trained with skip-connections.

In step 202, a Homomorphic Encryption (HE) analyzer is run to compute a cost of having skip-connections between every pair of layers.

In step 203, a skip-connection layer with a cost greater than a predetermined value by using a smooth transition is removed (i.e., latency is higher than a value). And, in step 204, new skip-connections are added where a cost is less than a predetermined value (i.e., a second predetermined value such as when the chain index is the same and when a packing matches). The second predetermined value can also be a set latency threshold.

It is noted that steps 203-204 can be merged into a single step of directly assigning new skip-connections or smoothly move to the new skip-connections.

In step 205, a modified CNN is returned based on a result of the adding and the removing.

And, in step 206, the network is trained for several more epoch connections.

However, if there is not an available pre-trained model, method 300 of FIG. 3 can start from “scratch” and be a heuristic solution by working on a neural network that has never been trained.

In step 301, a Homomorphic Encryption (HE) analyzer can be run to compute a cost of having skip-connections between every pair of layers.

In step 302, starting from layer i=1 to find a first layer j with a minimal cost, the invention adds a skip-connection, set i=j+1 and this is repeated until i=N (i.e., no more layers).

In step 303, a modified network is trained with the added skip-connection(s). And, in step 304, the modified network is returned.

It is noted that “cost” generally refers to latency caused by a skip-connection, but cost can also include, for example, amortized latency, memory consumption, CPU power, etc.

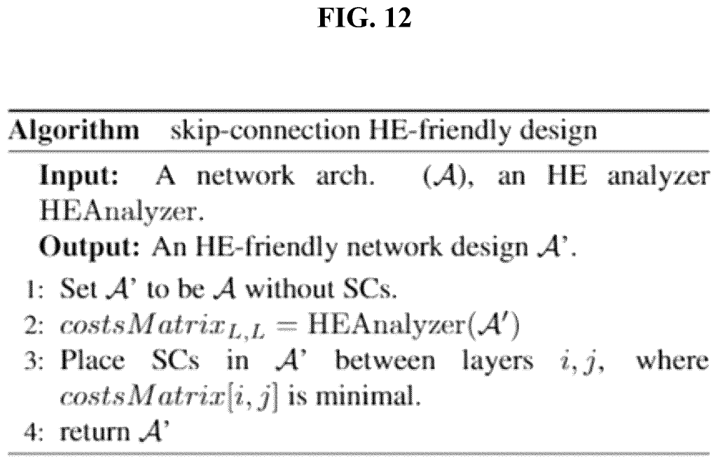

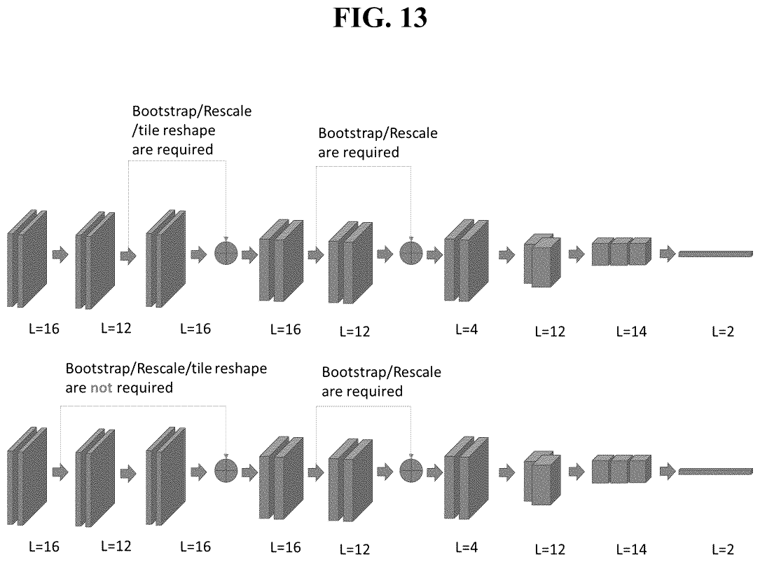

FIG. 12 exemplarily depicts an algorithm of which the method 200 and 300 are based on. The algorithm of FIG. 12 shows a way to examine which skip-connections are expensive in terms of the number of bootstrap operations and proposes efficient alternatives. For example, FIG. 13 depicts a use case for the algorithm of FIG. 12.

Specifically, when skip-connections are required, the algorithm of FIG. 12 is used for designing efficient HE-friendly CNNs. The algorithm uses as input a network architecture “A” and an HE network analyzer (HEAnalyzer), such as the optimizer of HELayers. The algorithm starts by removing all SC layers and feeding the new network A′ to the analyzer. For every pair of layers in the network i<j, the analyzer computes the latency costs of adjusting the output x and f(x) of layers i, j, using transformations g, h, respectively, and the need for bootstrap operations.

The algorithm returns the results in the matrix costsMatrix of size L×L, where Lis the number of layers in A′. For i≥j, costsMatrix[i][j]=∞. Using costsMatrix, the algorithm now places skip-connections to minimize the latency overhead while maintaining accuracy. One possible heuristic is to start from layer i=0 and find j=arg minj (costsMatrix[i][j]), and place a skip-connection(s) between layers i and j, and repeat with i=j+1. Note that when adding skip-connection(s) in a way that increases CIdx(h(f(x))), the costs matrix should be re-computed.

It is noted that the algorithm already considers the bootstrapping costs, and it most likely choses skip-connections for layers with Cidx(g(x))≤Cidx(h(f(x))).

Thereby, the network can be optimized by identifying how to maintain skip-connections while reducing latency.

And, the invention can provide a smooth transition from a skip-connection neural network to a skip-connection-free neural network.

### Exemplary Aspects, Using a Cloud Computing Environment

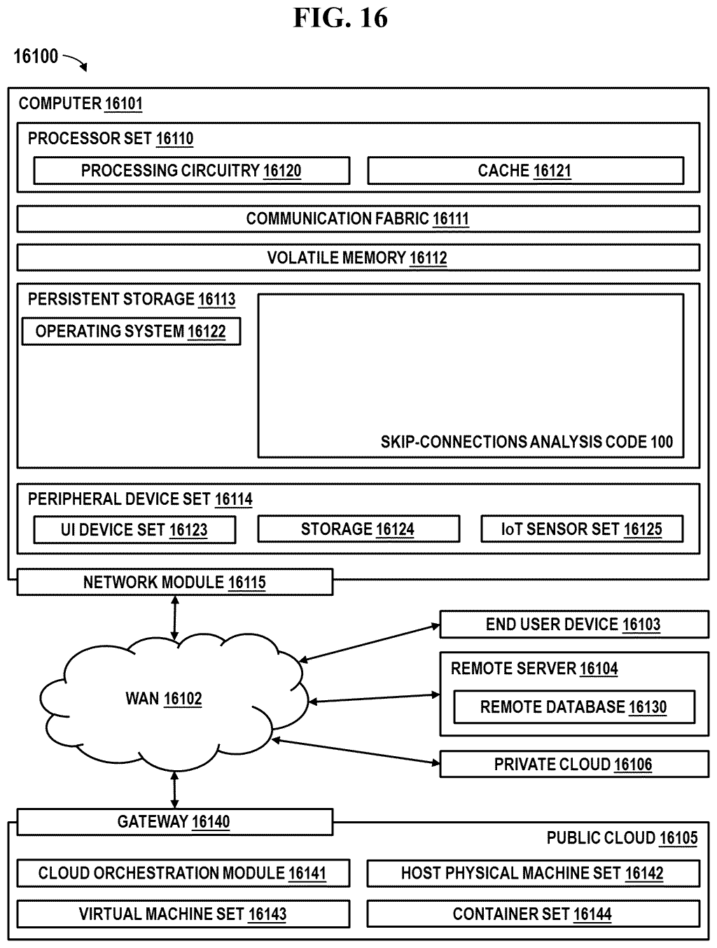

With reference now to FIG. 16, computing environment 16100 contains an example of an environment for the execution of at least some of the computer code involved in performing the inventive methods, such as skip-connections analysis code 100 (or code for methods 200 and 300). In addition to block 100, computing environment 16100 includes, for example, computer 16101, wide area network (WAN) 16102, end user device (EUD) 16103, remote server 16104, public cloud 16105, and private cloud 16106. In this embodiment, computer 16101 includes processor set 16110 (including processing circuitry 16120 and cache 16121), communication fabric 16111, volatile memory 16112, persistent storage 16113 (including operating system 16122 and block 100, as identified above), peripheral device set 16114 (including user interface (UI) device set 16123, storage 16124, and Internet of Things (IoT) sensor set 16125), and network module 16115. Remote server 16104 includes remote database 16130. Public cloud 16105 includes gateway 16140, cloud orchestration module 16141, host physical machine set 16142, virtual machine set 16143, and container set 16144.

COMPUTER 16101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 16130. As is well understood in the art of computer technology, and depending upon the technology, performance of a computer-implemented method may be distributed among multiple computers and/or between multiple locations. On the other hand, in this presentation of computing environment 16100, detailed discussion is focused on a single computer, specifically computer 16101, to keep the presentation as simple as possible. Computer 16101 may be located in a cloud, even though it is not shown in a cloud in FIG. 16. On the other hand, computer 16101 is not required to be in a cloud except to any extent as may be affirmatively indicated.

PROCESSOR SET 16110 includes one, or more, computer processors of any type now known or to be developed in the future. Processing circuitry 16120 may be distributed over multiple packages, for example, multiple, coordinated integrated circuit chips. Processing circuitry 16120 may implement multiple processor threads and/or multiple processor cores. Cache 16121 is memory that is located in the processor chip package(s) and is typically used for data or code that should be available for rapid access by the threads or cores running on processor set 16110. Cache memories are typically organized into multiple levels depending upon relative proximity to the processing circuitry. Alternatively, some, or all, of the cache for the processor set may be located “off chip.” In some computing environments, processor set 16110 may be designed for working with qubits and performing quantum computing.

Computer readable program instructions are typically loaded onto computer 16101 to cause a series of operational steps to be performed by processor set 16110 of computer 16101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 16121 and the other storage media discussed below. The program instructions, and associated data, are accessed by processor set 16110 to control and direct performance of the inventive methods. In computing environment 16100, at least some of the instructions for performing the inventive methods may be stored in block 100 in persistent storage 16113.

COMMUNICATION FABRIC 16111 is the signal conduction path that allows the various components of computer 16101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 16112 is any type of volatile memory now known or to be developed in the future. Examples include dynamic type random access memory (RAM) or static type RAM. Typically, volatile memory 16112 is characterized by random access, but this is not required unless affirmatively indicated. In computer 16101, the volatile memory 16112 is located in a single package and is internal to computer 16101, but, alternatively or additionally, the volatile memory may be distributed over multiple packages and/or located externally with respect to computer 16101.

PERSISTENT STORAGE 16113 is any form of non-volatile storage for computers that is now known or to be developed in the future. The non-volatility of this storage means that the stored data is maintained regardless of whether power is being supplied to computer 101 and/or directly to persistent storage 16113. Persistent storage 16113 may be a read only memory (ROM), but typically at least a portion of the persistent storage allows writing of data, deletion of data and re-writing of data. Some familiar forms of persistent storage include magnetic disks and solid state storage devices. Operating system 16122 may take several forms, such as various known proprietary operating systems or open source Portable Operating System Interface-type operating systems that employ a kernel. The code included in block 100 typically includes at least some of the computer code involved in performing the inventive methods.

PERIPHERAL DEVICE SET 16114 includes the set of peripheral devices of computer 16101. Data communication connections between the peripheral devices and the other components of computer 16101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 16123 may include components such as a display screen, speaker, microphone, wearable devices (such as goggles and smart watches), keyboard, mouse, printer, touchpad, game controllers, and haptic devices. Storage 16124 is external storage, such as an external hard drive, or insertable storage, such as an SD card. Storage 16124 may be persistent and/or volatile. In some embodiments, storage 16124 may take the form of a quantum computing storage device for storing data in the form of qubits. In embodiments where computer 16101 is required to have a large amount of storage (for example, where computer 16101 locally stores and manages a large database) then this storage may be provided by peripheral storage devices designed for storing very large amounts of data, such as a storage area network (SAN) that is shared by multiple, geographically distributed computers. IoT sensor set 16125 is made up of sensors that can be used in Internet of Things applications. For example, one sensor may be a thermometer and another sensor may be a motion detector.

NETWORK MODULE 16115 is the collection of computer software, hardware, and firmware that allows computer 16101 to communicate with other computers through WAN 16102. Network module 16115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 16115 are performed on the same physical hardware device. In other embodiments (for example, embodiments that utilize software-defined networking (SDN)), the control functions and the forwarding functions of network module 16115 are performed on physically separate devices, such that the control functions manage several different network hardware devices. Computer readable program instructions for performing the inventive methods can typically be downloaded to computer 16101 from an external computer or external storage device through a network adapter card or network interface included in network module 16115.

WAN 16102 is any wide area network (for example, the internet) capable of communicating computer data over non-local distances by any technology for communicating computer data, now known or to be developed in the future. In some embodiments, the WAN 16102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 16103 is any computer system that is used and controlled by an end user (for example, a customer of an enterprise that operates computer 16101), and may take any of the forms discussed above in connection with computer 16101. EUD 16103 typically receives helpful and useful data from the operations of computer 16101. For example, in a hypothetical case where computer 16101 is designed to provide a recommendation to an end user, this recommendation would typically be communicated from network module 16115 of computer 16101 through WAN 16102 to EUD 16103. In this way, EUD 16103 can display, or otherwise present, the recommendation to an end user. In some embodiments, EUD 16103 may be a client device, such as thin client, heavy client, mainframe computer, desktop computer and so on.

REMOTE SERVER 16104 is any computer system that serves at least some data and/or functionality to computer 16101. Remote server 16104 may be controlled and used by the same entity that operates computer 16101. Remote server 16104 represents the machine(s) that collect and store helpful and useful data for use by other computers, such as computer 16101. For example, in a hypothetical case where computer 16101 is designed and programmed to provide a recommendation based on historical data, then this historical data may be provided to computer 16101 from remote database 16130 of remote server 16104.

PUBLIC CLOUD 16105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 16105 is performed by the computer hardware and/or software of cloud orchestration module 16141. The computing resources provided by public cloud 16105 are typically implemented by virtual computing environments that run on various computers making up the computers of host physical machine set 16142, which is the universe of physical computers in and/or available to public cloud 16105. The virtual computing environments (VCEs) typically take the form of virtual machines from virtual machine set 16143 and/or containers from container set 16144. It is understood that these VCEs may be stored as images and may be transferred among and between the various physical machine hosts, either as images or after instantiation of the VCE. Cloud orchestration module 16141 manages the transfer and storage of images, deploys new instantiations of VCEs and manages active instantiations of VCE deployments. Gateway 16140 is the collection of computer software, hardware, and firmware that allows public cloud 16105 to communicate through WAN 16102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 16106 is similar to public cloud 16105, except that the computing resources are only available for use by a single enterprise. While private cloud 16106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 16105 and private cloud 16106 are both part of a larger hybrid cloud.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Further, Applicant's intent is to encompass the equivalents of all claim elements, and no amendment to any claim of the present application should be construed as a disclaimer of any interest in or right to an equivalent of any element or feature of the amended claim.

What is claimed is:

1. A computer-implemented skip-connections analysis method for neural networks by removing skip-connections, the method comprising:
training a network with skip-connections; and
breaking a dependency within the network on the skip-connections.

2. The computer-implemented skip-connections analysis method of claim 1, wherein the breaking the dependency within the network includes:
replacing skip-connections with smooth transition skip-connection (ST-SC) layers;
training the network for N epochs, where N is an integer; and
returning the network without the skip-connections.

3. The computer-implemented skip-connections analysis method of claim 2, wherein the network is trained for additional epochs before returning the network without the skip-connections.

4. The computer-implemented skip-connections analysis method of claim 2, wherein the breaking the dependency includes removing all of the skip-connections at a same time when there are more than a single skip-connection in the network.

5. The computer-implemented skip-connections analysis method of claim 1, wherein the breaking the dependency includes removing the skip-connections one-by-one based on a policy.

6. The computer-implemented skip-connections analysis method of claim 1, embodied in a cloud-computing environment.

7. A skip-connections analysis computer program product for accelerating neural networks by removing skip-connections, the skip-connections analysis computer program product comprising a computer-readable storage medium having program instructions embodied therewith, the program instructions executable by a computer to cause the computer to perform:
training a network with skip-connections; and
breaking a dependency within the network on the skip-connections.

8. The skip-connections analysis computer program product of claim 7, wherein the breaking the dependency within the network includes:
replacing skip-connections with smooth transition skip-connection (ST-SC) layers;
training the network for N epochs, where N is an integer; and
returning the network without the skip-connections.

9. The skip-connections analysis computer program product of claim 8, wherein the network is trained for additional epochs before returning the network without the skip-connections.

10. The skip-connections analysis computer program product of claim 7, wherein the breaking the dependency includes removing all of the skip-connections at a same time when there are more than a single skip-connection in the network.

11. The skip-connections analysis computer program product of claim 7, wherein the breaking the dependency includes removing the skip-connections one-by-one based on a policy.

12. A skip-connections analysis system for accelerating neural networks by removing skip-connections, said skip-connections analysis system comprising:
a processor; and
a memory, the memory storing instructions to cause the processor to perform:
training a network with skip-connections; and
breaking a dependency within the network on the skip-connections.

13. The skip-connections analysis system of claim 12, wherein the breaking the dependency within the network includes:
replacing skip-connections with smooth transition skip-connection (ST-SC) layers;
training the network for N epochs, where N is an integer; and
returning the network without the skip-connections.

14. The skip-connections analysis system of claim 13, wherein the network is trained for additional epochs before returning the network without the skip-connections.

15. The skip-connections analysis system of claim 12, wherein the breaking the dependency includes removing all of the skip-connections at a same time when there are more than a single skip-connection in the network.

16. The skip-connections analysis system of claim 12, wherein the breaking the dependency includes removing the skip-connections one-by-one based on a policy.

17. The skip-connections analysis system of claim 12, embodied in a cloud-computing environment.

18. A computer-implemented skip-connections analysis method for an efficient skip-connection realization, the method comprising:
optimizing a network by identifying skip-connections to maintain while reducing latency.

19. The computer-implemented skip-connections analysis method of claim 18, wherein, starting from a pre-trained model, the optimizing includes:
training the network with the skip-connections;
running an analyzer to compute a cost of having the skip-connections between layers of the network;
adding and/or removing the skip-connections from the network based on a result of the analyzer; and
returning the modified network based on a result of the adding and/or removing.

20. The computer-implemented skip-connections analysis method of claim 18, wherein the optimizing includes:
training the network with the skip-connections;
running an analyzer to compute a cost of having the skip-connections between layers of the network;
adding and/or removing the skip-connections from the network based on a result of the analyzer; and
returning the modified network based on a result of the adding and/or removing.

21. The computer-implemented skip-connections analysis method of claim 18, wherein, starting from a pre-trained model, the optimizing includes:
training the network with the skip-connections;
running an analyzer to compute a cost of having the skip-connections between layers of the network;
removing a skip-connection based on the cost having a predetermined value;
adding a new skip-connection based on the cost having a second predetermined value;
returning the modified network based on a result of the adding and/or removing.

22. The computer-implemented skip-connections analysis method of claim 20, wherein the second predetermined value includes when the chain index is a same and when a packing matches.

23. The computer-implemented skip-connections analysis method of claim 18, wherein, starting without a pre-trained model, the optimizing includes:
running an analyzer to compute a cost of having the skip-connections between layers of the network;
starting from an initial layer of the network, finding a first layer with a minimal cost to add a skip-connection to the first layer;
training the modified network; and
returning the modified network.

24. The computer-implemented skip-connections analysis method of claim 23, wherein the finding the first layer is repeated.

25. A skip-connections analysis system for an efficient skip-connection realization, the system comprising:
a processor; and
a memory, the memory storing instructions to cause the processor to perform:
training the network with the skip-connections;
running an analyzer to compute a cost of having the skip-connections between layers of the network;
adding and/or removing the skip-connections from the network based on a result of the analyzer; and
returning the modified network based on a result of the adding and/or removing.
